(19) United States
(12) Patent Application Publication
(10) Pub. No.: US 2010/0061247 A1
(43) Pub. Date: Mar. 11, 2010

(54) Counting method and network control device

(76) Inventor: Jing He, Beijing (CN)

Correspondence Address: STAAS & HALSEY LLP, SUITE 700, 1201 NEW YORK AVENUE, N.W., WASHINGTON, DC, 20005, US

(21) Appl. No.: 12/311,434

(22) PCT Filed: Oct. 1, 2007
(86) PCT No.: PCT/EP2007/060389

§ 371 Date: Nov. 6, 2009

(30) Foreign Application Priority Data
Sep. 30, 2006 (CN) 200610141585.4

(51) Int. Cl. H04L 12/26; H04H 20/71; H04W 72/00

(52) U.S. Cl. 370/241; 370/312; 455/450

(57) ABSTRACT

A counting method pre-establishes a user equipment information record and a user number threshold in a cell. The method includes: A. informing UEs in the cell where multimedia broadcast and multicast service is transmitted about the beginning of the counting, receiving a response from the UEs, and recording the responded UE records into the UE information record; B. monitoring the cell, and updating the UE information record when determining that a UE having a varied communication behavior in the cell; C. according to the UE number in the UE information record and the user number threshold in the cell, determining whether to trigger a re-counting or not, and if yes, returning to Step A; otherwise, returning to Step B. A network control device includes a storage module, a control module, and a communication module. Through the technical solution, the accuracy for determining the MBMS operation transmission mode at the network side is improved.

### CROSS REFERENCE TO RELATED APPLICATIONS

This application is based on and hereby claims priority to PCT Application No. PCT/EP2007/060389 filed on Oct. 1, 2007 and Chinese Application No. 200610141585.4 filed on Sep. 30, 2006, the contents of which are hereby incorporated by reference.

### BACKGROUND OF THE INVENTION

The present invention involves multimedia broadcast multicast service (MBMS) technology, especially the counting method and network control devices used for counting in MBMS.

With the rapid development of mobile communication technology, mobile communication networks are being extensively used and the number of mobile communication users is increasing sharply, and MBMS technology is appearing on mobile communication networks. As this technology is characterized by its low resource usage and high performance, has made it a crucial technology in mobile communication systems.

Networks can use a peer to peer (PTP) pattern or a peer to multi peer (PTM) pattern to transmit MBMS service data to multiple users within a cell. If a relatively small number of users accept MBMS service in a cell, the PTP mode will be used; the network side will then transmit MBMS service data to user equipment (UE) used by corresponding users through various dedicated traffic channels (DTCH). When there are a relatively large number of users in the cell, the PTM mode will be used; the network side will then transmit MBMS service data to all users involved in the MBMS service or users showing an interest in MBMS service by use of the MBMS MTCH. Adjusting the transmission mode not only allows a saving in radio resources for the air interface, but the transmission power of base stations can also be reduced.

To verify whether the PTP mode or the PTM mode should be used in a cell, the number of UE in the cell is usually obtained, with the radio network controller (RNC) initiating the primary counting and recounting processes. As prescribed in the protocol, when an MBMS service session is initiated, the RNC will count the number of UE accepting MBMS service in the cell by use of the primary counting process. During such a MBMS service session, RNC will count the number of UE accepting MBMS service in a cell once again by performing the counting process once again if it is necessary to count the number of UE once again. During a MBMS service session, the recount may be performed numerous times.

In current counting methods, a pre-determined time section and a threshold for the setup of PTM are set, and the number of UE in the cell is counted in the pre-set time section, i.e. the primary count and recount are performed. Where the number of UE in the cell is less than the threshold for the setup of PTM, a recount can only be triggered when the pre-set time section has ended. Where such a method is used to trigger recounting, it is necessary to wait for the end of the pre-set time section after counting the number of UE; only then can it be determined whether a recount need be triggered. As the mobility, activation and de-activation of UE are highly random, it is possible for the number of UE in the cell to change greatly within a short period of time. It is certainly impossible for a counting method which uses regular recount triggering to give an accurate number of users accepting MBMS service in a timely manner; it is thus impossible for the network side to determine accurately which transmission mode is currently the best choice. As a result, radio resources are wasted.

### SUMMARY

The inventor proposes a counting method which can make the network side's determination of transmission modes for MBMS service more accurate.

In the counting method proposed by the inventor, a user equipment (UE) information record and a user number threshold in a cell are pre-established. The method further includes:
A. informing UE in the cell where multimedia broadcast and multicast service (MBMS) is transmitted of the initiation of the count, receiving a response from the UE, and recording the responding UE in a UE information record;
B. monitoring the cell and updating the UE information record when it is determined that a UE with variant communication behavior has appeared in the cell;
C. determining whether to trigger a recount or not according to the number of UE in the UE information record and the user number threshold in the cell; if this is required, A is repeated; otherwise, B is repeated.

A, where the responding UE are recorded in the UE information record, preferably includes:

The channel state of the responding UE is determined; if the UE is in a universal mobile telecommunication system (UMTS) universal terrestrial radio access network (UTRAN) registration area paging channel (URA_PCH), in a cell paging channel (CELL_PCH) or in a cell forward access channel (CELL_FACH), an identifier is allocated to the UE; if the UE is in a cell dedicated channel, the identifier corresponding to the UE is acquired externally and allocated;
The identifier for the responding UE will be used as UE information and recorded in the UE information record.

Prior to recording the identifier of the responding UE in the UE information record as the UE information, this should preferably further comprise:

It should be determined whether an identifier for the UE exists in the UE information record or not; if this exists, B should be performed; otherwise, the operation to record the identification into the UE information record should be performed.

In A, where UE in the cell where the MBMS is transmitted are informed of the initiation of a count, the cell should preferably use a peer to multi peer (PTM) transmission mode; accordingly, B, of updating the UE information record when the existence of a UE with variant communication behavior is determined, comprises:

B11. It should be determined whether the UE is already participating in the MBMS service and enters the cell, is powered on or enters the service area, or whether the UE is accessing the MBMS service; if so, the existence of a UE with variant communication behavior is determined, and the information for the UE is added to the UE information record, and B12 is then performed; otherwise, B12 should be performed directly;
B12. It should be determined whether the UE in the cell stored in the UE information record has left the cell, is powered off or has left the service area, or whether the UE has quit the MBMS service; if so, the existence of a UE with variant communication behavior in the cell is determined, and the information of the UE is deleted from the UE information record; otherwise, it is determined that no UE display variant communication behavior in the cell.

C, of determining whether to trigger a recount or not according to the UE number and the user number threshold in the cell in the UE information record, preferably comprises:

It should be determined whether the UE number in the UE information record is smaller than the user number threshold in the cell; if so, a recount should be triggered; otherwise, a recount should not be triggered.

In A, where UE in the cell where the MBMS is transmitted are informed of the initiation of a count, the cell should preferably use a peer to multi peer (PTM) transmission mode; accordingly, B, where the UE information record is updated when the existence of a UE with variant communication behavior is determined, comprises:

B21. It should be determined whether the UE in the cell stored in the UE information record has left the cell, is powered off or has left the service area, or whether the UE has quit the MBMS service; if so, the existence of a UE with variant communication behavior in the cell is determined, and the information of the UE is deleted from the UE information record, and B22 is then performed; otherwise, B22 should be performed directly.
B22. It should be determined whether the UE is already participating in the MBMS service and enters the cell, is powered on or enters the service area, or whether the UE is accessing the MBMS service; if so, the existence of a UE with variant communication behavior is determined, and the information for the UE is added to the UE information record; otherwise, it is determined that no UE with variant communication behavior exist in the cell.

Wherein, C, where it is determined whether a recount should be triggered or not according to the UE number and the user number threshold in the cell in the UE information record, comprises:

It is determined whether the UE number in the UE information record is smaller than the user number threshold in the cell; if so, a recount should be triggered; otherwise, a recount should not be triggered.

Preferably, adding the information of the UE into the UE information record comprises: adding the information of the UE into the UE information record as a new item, and adding 1 to the number of UE in the UE information record or replacing a UE information listing in the UE information record with information of the UE, and maintaining the number of UE in the UE information record unchanged.

Deleting the information of the UE from the UE information record should preferably comprise: removing the information of the UE from the UE information record, and subtracting 1 from the number of UE in the UE information record.

Before C returns to A, C should preferably further comprise: the UE information record should be cleaned up.

A transmission mode switching condition should preferably even be pre-set, and before C returns to the A, C should further comprise:

The count result should be determined according to the number of UE in the UE information record, and if it is determined to switch transmission mode, the transmission mode in the cell should be switched according to the count result and the transmission mode switching condition.

The inventor also proposes a kind of network control device to be used for counting which can help to make the network side's determination of transmission modes for MBMS service more accurate.

The network control device proposed by the inventor includes a storage module, a communication module and a control module, wherein:

The storage module is used to store a user equipment (UE) information record and a user number threshold in the cell;
The communication module is used to receive a notification indicating the initiation of a count from the control module, transmit the received notification, receive a response from UE, and transmit the received response to the control module;
The control module is used to transmit the notification indicating the initiation of a count to the communication module, receive UE responses from the communication module, transmit information on responding UE to the storage module, obtain the UE information record and the user number threshold in the cell from the storage module, monitor the cell where the MBMS is transmitted, inform the storage module to update the UE information record, and determine whether to trigger a recount or not according to the UE number and the user number threshold in the cell in the UE information record.

Preferably, the storage module should be further used to store count results and transmission switching conditions;

The control module is further used to transmit the count result of each recount to the storage module, obtain the count result and the transmission switching conditions from the storage module, and, when it is determined to switch the transmission mode, switch the transmission mode of the cell according to the obtained transmission mode switching conditions and the count result.

Preferably, the network control device is a radio network controller RNC or eNode B.

In the proposal, UE responding to the network side will be counted in the count and this information will be stored in the UE information record. Meanwhile, in the MBMS session, the cell where the MBMS is transmitted will be monitored, and the UE information record will be dynamically updated according to the monitoring result. A recount is triggered when the UE number in the UE information record exceeds the pre-established user number threshold in the cell. It is clear that the statistics for UE receiving MBMS service will be used as a condition to trigger a recount. As long as the trigger condition is met, a recount is triggered immediately, which makes it possible to reflect the number of users currently receiving MBMS service accurately and in a timely manner, enabling the network side to rapidly select the transmission mode most suitable to the present situation, effectively improving the accuracy of determining the MBMS service transmission mode while preventing the wastage of radio resources.

In the method proposed by the inventor, a recount is additionally triggered based on the number of users receiving MBMS service, i.e. the times that a recount is triggered is correlated to changes in the user number. During the count, if the update method includes adding UE newly added during the present count to the UE information record, the UE number in the UE information record will increase gradually to exceed the user number threshold in the cell. If the PTM transmission mode is selected when the present count is initiated, no recount is triggered when the UE number exceeds the user number threshold in the cell. During the count, if the update method includes clearing up the UE information record for each count and removing the information of the UE which meet conditions for deletion from the UE information record during monitoring, the UE number in the UE information record will not be very large and the probability of exceeding the user number threshold in the cell will decrease. In such a case, where the PTM transmission mode is adopted when the count is initiated, a recount will not be triggered when the UE number is lower than the user number threshold in the cell. Clearly, in the present invention, frequent recounts can be avoided through the reverse control of the user number in the information record; the load on the network control device will be relieved accordingly, and radio resources will be further saved.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a sample flow chart for a count method based on the theory of the proposed method.

FIG. 2 is a flow chart for the count method in Implementation 1 of the proposed method.

FIG. 3 is a flow chart for the count method in Implementation 2 of the proposed method.

FIG. 4 is a schematic diagram of the structure of network control devices used for counting in implementations of the proposed method.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

In the method and device proposed by the inventor, information on the UE responding to the count in the cell is placed on record when either the first count or a recount are initiated, while UE in the cell are monitored and the UE information record updated according to UE status.

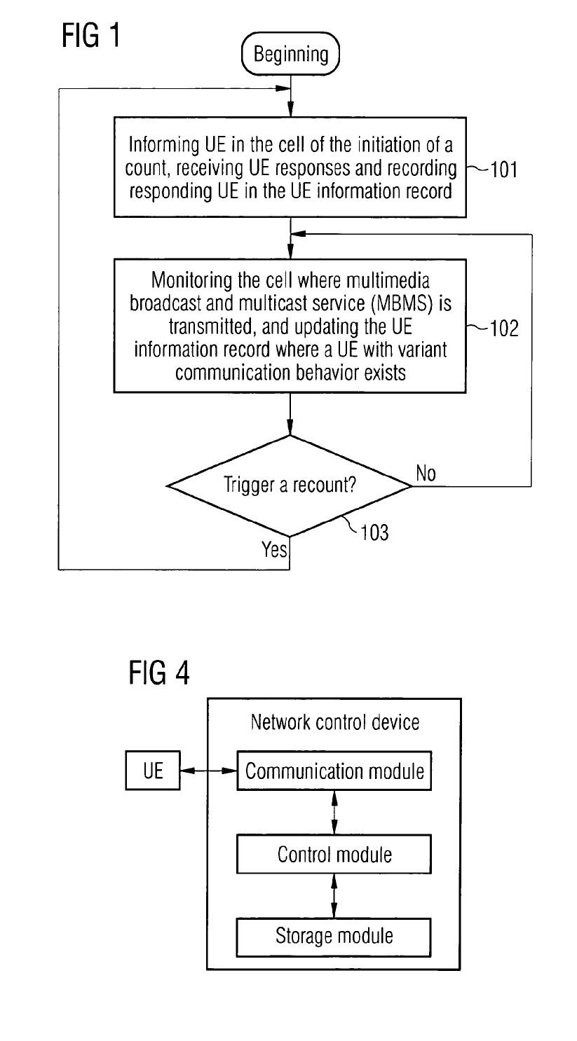

FIG. 1 is a sample flow chart for the count method based on the theory of the proposed method. With reference to FIG. 1, it can be seen that the UE information record and the user number threshold in a cell are pre-established; in 101, UE in the cell are informed of the initiation of the count, a response is received from the UE, and the responding UE are recorded in the UE information record; in 102, the cell is monitored and the UE information record is updated when a UE with variant communication behavior appears in the cell; in 103, it is determined whether a recount should be triggered or not according to the UE number in the UE information record and the pre-established user number threshold in the cell; if so, the process returns to 101; otherwise, it returns to 102.

The count is implemented in the interoperability between the network control device and UE. The RNTI of UE or other signs identifying UE can be recorded in the UE information record as UE information when the network control device receives a response from the UE to the count notification. Changes in communication behavior should also at least include: a UE entering or leaving the cell, powering on or off, entering or leaving the service area, and accepting or quitting the MBMS service, etc. A detailed description will be given below.

### Implementation 1

In the present implementation, the network control device is RNC and the network side uses the PTM mode to transmit data on MBMS service at the beginning of the count.

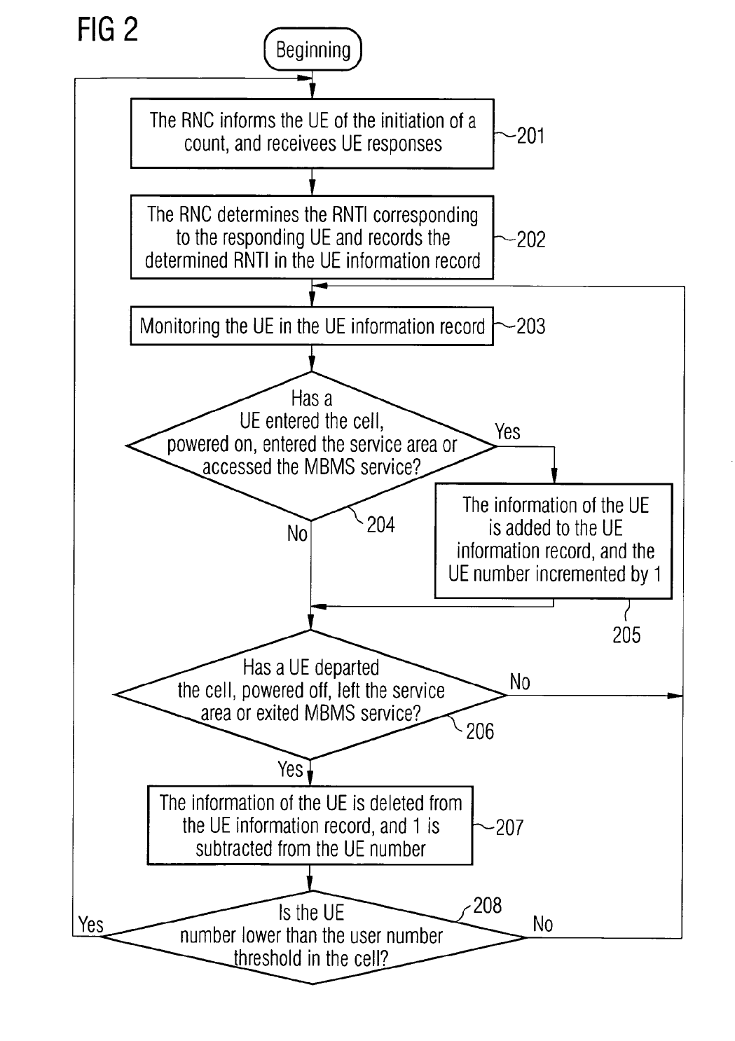

FIG. 2 is a flow chart of the count method in the present implementation. With reference to FIG. 2, the method includes:

In 201, RNC informs UE of the initiation of a count and receives the response from UE.

If it is necessary for the RNC to count UE receiving MBMS in the cell, MBMS access information is transmitted to the UE in the cell as part of this step. When any UE receiving such information is IDLE and can respond to such information, it establishes an RRC connection between itself and the network side, and responds to the MBMS access information sent by RNC through the RRC connection established. If the UE receiving the MBMS access information is in a state such as URA_PCH, CELL_PCH or CELL_FACH, and the cell of the connected mode count area in the received MBMS access information indicates that the count is suitable for such UE, the above-mentioned UE triggers the cell updating process to respond to the MBMS access information. UE in CELL_DCH state possess the exclusive physical channel assigned by the network side, and RNC can momentarily receive the MBMS information of the UE from CN through the RANAP, and thereby determine whether the UE is participating in MBMS service. Although such UE are not involved in the count, they are also included in the UE responding to the MBMS count.

In 202, RNC determines the RNTI corresponding to the responding UE and records the determined RNTI record in the UE information record.

In radio communication networks, RNTI represents the identifier of the UE in transmission signaling in UTRAN, SRNC, DRNC and the cell or between UE and UTRAN. In such a step, if RNC determines that the responding UE is IDLE, the UE will be switched to CELL_FACH state; once a new RNTI is assigned to the UE, the RNTI will be included in the RRC CONNECTION SETUP message and transmitted to the UE. The RNTI is then stored in the UE information record for that RNC. If RNC determines that the responding UE is in a URA_PCH, CELL_PCH or CELL_FACH state, the paging channel state of the UE will remain unchanged; when a new RNTI is assigned to the UE, the RNTI will be included in the CELL UPDATE CONFIRM message and transmitted to the UE, and it will be stored in the UE information record of that RNC. At the same time, the RNC stores the RNTI corresponding to the UE in CELL_DCH state participating in the present MBMS service in the UE information record of that RNC.

As not all UE respond to information on the initiation of a count transmitted by RNC, the UE information stored in the UE information record only includes information on UE interested in the present MBMS service.

In 203˜205, the RNC monitors the cell transmitting the present MBMS service and determines whether a UE participating in the present MBMS service enters the present cell, is powered on or enters the service area, or if a UE participating in the present MBMS service appears in the cell. If so, the UE information is recorded in the UE information record, the UE number is incremented by 1, and the process proceeds to return to 206; otherwise, it returns to 206 directly.

In radio communication systems, the RNC can identify UE entering the cell by examining the process of the UE initiating a cell update or by connecting with the UE. It can also determine a UE powering on or entering the service area by examining the process whereby the UE starts establishing RRC, and determining whether the UE is participating in the present MBMS service by examining the process whereby the UE initiates the activation of the MBMS multicast service. Where the UE performs any of the above-mentioned changes in communication behavior, the UE should be regarded as a terminal that receives MBMS service data. RNC thus adds the RNTI of the UE to the UE information record; it then adds 1 to the UE number in the current UE information record.

206˜207 determine whether the UE stored in the UE information record in the cell leaves the cell, is powered off, departs from the service area or quits the present MBMS service. If so, the UE information is deleted from the UE information record, and 1 is subtracted from the UE number in the UE information record; otherwise, the process returns to 203.

In a similar way to when UE enters the cell, is powered on or participates in the MBMS service, RNC can identify UE leaving the cell by examining the process whereby the UE initiates an update of the cell stored in the UE information record or by connecting with the UE. It can also determine whether the UE powers off or leaves the service area by examining the process whereby the UE triggers the release of RRC, and determine if the UE is quitting the present MBMS service by examining the process whereby the UE initiates the deactivation of MBMS multicast service. If any of the above-mentioned changes occur in the communication behavior of UE in the UE information record, the UE will no longer be a terminal receiving MBMS service data. The RNC thus deletes the RNTI of the UE from the UE information record and then subtracts 1 from the UE number in the current UE information record.

208 determines whether the UE number in the UE information record is lower than the pre-established user number threshold in a cell. If yes, the process returns to 201; otherwise, it returns to 203.

In the present implementation, the user threshold in the cell is pre-determined for the MBMS service so as to help the network side use the PTM mode or the PTP mode to transmit MBMS service data. When the UE number in the UE information records drops lower than the user threshold in the cell, this indicates that the UE number receiving MBMS service data in the cell is small. As this count initially uses the PTM mode, the network side must obtain accurate count results, and determine whether the PTM mode is the best current transmission mode according to the count results; RNC thus determines to trigger a recount. When the recount begins, RNC updates the UE information record. During this update, the UE number in the UE information record can be regarded as the count result of the previous count; the UE information record is deleted, and the RNTI of the responding UE is once again added to the UE information record upon receiving responses; it is also acceptable to use the UE number in the UE information record as the count result of the previous count prior to the receipt of responses, and keep the UE information record unchanged. Upon receiving the UE response, it should be determined whether the RNTI of the UE has been stored in the UE information record; if so, the UE information record should remain unchanged; otherwise, the RNTI of that UE should be added to the UE information record.

This concludes the count flow of the present implementation.

In the present implementation, the PTM mode is used when the count is initiated, and the increase in the UE number receiving MBMS service will not affect the switching of transmission modes. To prevent the UE information record from occupying too much space, the RNTI for UE entering the cell, powering on, entering the service area or for UE participating in the MBMS service can be used in 205 mentioned above to replace the RNTI of any UE in the UE information record. The UE number in the UE information record thus remains unchanged.

Additionally, after performing the recount, when conditions for switching the pre-determined transmission mode are met, for example where the count results of a plurality of continuous recounts are all lower than the user number threshold in the cell, a switch is then made to MBMS transmission mode. In the present implementation, the transmission mode should be switched from PTM mode to PTP mode.

### Implementation 2

In the present implementation, the network control device is still RNC. The present implementation differs from the previous implementation, however, in that the network side uses the PTP pattern to transmit MBMS service data when the count process begins.

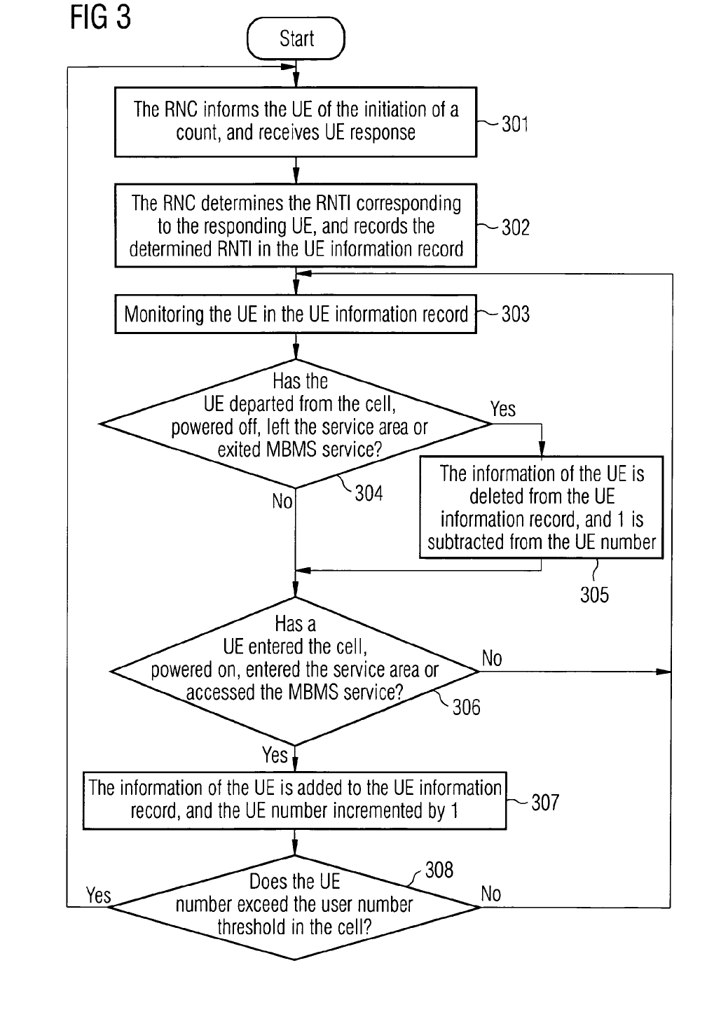

FIG. 3 shows the flow of the count method in this implementation. Referring to FIG. 3, this method consists of the following:

In 301˜302, RNC informs the UE of the initiation of a count and receives responses from the UE; RNC determines the RNTI of the responding UE and adds the determined RNTI to the UE information record.

The operations of the above-mentioned two steps are the same as those of 101˜102 in Implementation 1.

In 303˜305, RNC monitors the cell transmitting the present MBMS service and determines whether any UE stored in the UE information record departs from the cell, powers off, or leaves the service area, or whether the UE quits the MBMS service; if so, the information for the UE is deleted from the UE information record and 1 is subtracted from the UE number in the UE information record, and the process continues to 306; otherwise, 306 is implemented directly.

The method for determining the departure from the cell, power-off or exit from the service area of a UE, or its removal from the MBMS service, is the same as 204 in Implementation 1.

306˜307 determine whether a UE already participating in the MBMS service enters the cell, is powered on or enters the service area, or whether a UE not previously participating in the MBMS service accesses the MBMS service; if so, the information of the UE is added to the UE information record and the UE number is incremented by 1; otherwise, the process returns to 303.

The method to determine whether a UE enters the cell, is powered on or participates in the MBMS service is the same as that in 206 of this implementation.

308 determines whether the UE number in the UE information record exceeds the pre-established user number threshold in a cell; if so, the process returns to 301; otherwise, it returns to 303.

In this implementation, a user number threshold in the cell is also pre-established for the MBMS service. When the UE number in the UE information record increases to exceed the user number threshold in a cell, this indicates that a rather large number of UE in the cell receive data on the MBMS service. As the PTP mode is used when triggering the count, the network side can directly change the transmission dialogue from PTP mode to PTM mode while informing the relevant UE. If the network side needs to obtain more accurate count results, i.e. to determine whether the count results are consistent with the actual situation while determining whether the PTP mode is the optimal current transmission mode, RNC can determine and trigger a recount. When the recount starts, RNC can perform the operations in Implementation 1 and update the UE information record, i.e. re-completing the UE information record after storing the count results for the previous count or adding the RNTI for UE newly increased in this count into the UE information record.

This concludes the count flow of the present implementation.

In the present implementation, the PTP mode is used when the count starts and a decrease in the number of UE receiving the MBMS service will not affect the switch in transmission modes. Therefore, to prevent the UE information record from occupying too much space, it is acceptable to replace the RNTI of a random UE in the UE information record with the corresponding RNTI of UE entering the cell, powering on, entering the service area or where the UE participates in the MBMS service in 307 above. In this case, the UE number in the UE information record will maintain unchanged.

Moreover, having performed the recount, if the conditions for switching the pre-established transmission mode are met, for example where the UE number in the UE information record always exceeds the user number threshold in a cell in a plurality of consecutive recounts, the MBMS transmission mode should then be switched. In the present implementation, the transmission mode will be switched from the PTP mode to the PTM mode.

The above is only an implementation using RNC as a radio network control device. In the proposed device, eNode B in advanced 3G-communication systems can also act as a radio network device.

In the above two implementations, UE responding to the network side are counted and recorded in the UE information record during the count. The cell transmitting the MBMS service is also monitored and the UE information record is dynamically updated according to the monitoring results during the MBMS service session. When the UE number in the UE information record exceeds the pre-determined user number threshold in a cell, a recount is triggered. Clearly, the count results for UE receiving MBMS service is used as the condition for triggering the recount in the present implementation; where the conditions for triggering a recount are satisfied, the recount is triggered immediately. It is thus possible to reflect the number of users receiving data on MBMS service in the current instance accurately and in a timely manner, and enable the network side to rapidly select a transmission mode best suited to the current situation; the accuracy in determining the transmission mode for MBMS service is effectively improved while preventing the waste of radio resources.

A recount is also triggered according to the number of users receiving data on MBMS service in the above two implementations; i.e. the number of triggered recounts is related to changes in the number of users. During the count, the UE number in the UE information record gradually increases to exceed the user number threshold in a cell if this is updated by adding newly added UE in the current count into the UE information record. If the PTM transmission mode is used when the present count is triggered, a recount will not be triggered, as the UE number exceeds the user number threshold in a cell. If this is updated by clearing the UE information record when performing a count and the method for removing UE information satisfying the conditions for deletion from the UE information record during monitoring are using during the count, no excess UE will appear in the UE information record, and the probability of exceeding the user number threshold in a cell will also decrease. Thus, where the PTP transmission mode is used when the current count is initiated, the recount is not triggered when the UE number is lower than the user number threshold in a cell. It is clear that in the proposed method, cases of frequently triggered recounts can be prevented through the inversion of control over the number of users in the information record; in turn, the load on network control devices will be relieved and radio resources will be further saved.

An example sketch map of the network control device's structure in the implementations is demonstrated in FIG. 4 (See FIG. 4). The network control device can follow the flows in Implementations 1 and 2 to interact with UE while performing a count in the MBMS service session. Specifically, the network control device includes a storage module, a control module, and a communication module. The storage module is used to store a user equipment (UE) information record and a user number threshold in the cell; the communication module is used to receive a notification indicating the start of a count from the control module, transmit the received notification, receive responses from the UE, and transmit the received responses to the control module; the control module is used to transmit the notification indicating the start of a count to the communication module, receive the responses from the UE from the communication module, transmit information on responding UE to the storage module, obtain the UE information record and the user number threshold in the cell from the storage module, monitor the cell where the MBMS is transmitted, inform the storage module to update the UE information record, and determine whether to trigger a recount or not according to the UE number and the user number threshold in the cell in the UE information record.

Furthermore, in the present implementation, the storage module stores count results and transmission switching conditions; the control module is further used to transmit the count result of each recount to the storage module, to obtain the count result and the transmission switching conditions from the storage module, and, when it is determined to switch the transmission mode, switch the transmission mode of the cell according to the obtained transmission mode switching conditions and the count result.

In actual applications, the network control device in the present implementation can be a radio network controller RNC, eNode B, or other network entity that can perform a count.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-15. (canceled)

16. A counting method, which pre-establishes a user terminal information record and a user number threshold in a cell, comprising:
informing a plurality of user terminals in the cell in which multimedia broadcast and multicast service (MBMS) is transmitted of initiation of counting a number of the user terminals accepting MBMS service, receiving responses from the user terminals, and recording identification of the responding user terminals into the user terminal information record;
monitoring the cell, and updating the user terminal information record after the recording the identification of the responding user terminals into the user terminal information record when it is determined that a user terminal having a varied communication behavior exists in the cell;
determining whether to trigger a re-counting according to a number of user terminals and the user number threshold in the cell in the user terminal information record; and
informing the user terminals in the cell about initiation of re-counting, receiving responses from the user terminals, recording the new responding user terminals in the user terminal information record, monitoring the cell and updating the user terminal information record after the recording the responding user terminals into the user terminal information record when it is determined that a user terminal having a varied communication behavior exists in the cell, when a determination is made to trigger a re-counting, and monitoring the cell and updating the user terminal information record when it is determined that a user terminal having a varied communication behavior exists in the cell without informing the user terminals in the cell about initiation of re-counting, when a determination is made not to trigger the re-counting.

17. The method as claimed in claim 16, wherein the recording the identification of the responding user terminals into the user terminal information record comprises:
determining a channel state of each of the responding user terminals, and allocating an identification for the user terminal when the user terminal is in a state of a universal mobile telecommunication system universal terrestrial radio access network registration area paging channel, in a state of a cell paging channel or in a state of a cell forward access channel, and acquiring an identification corresponding to the user terminal externally when the user terminal is in a state of a cell dedicated channel; and
recording the identification of the responding user terminal into the user terminal information record as user terminal information.

18. The method as claimed in claim 17, further comprising:
determining whether the identification of the responding user terminal exists in the user terminal information record before the recording the identification of the responding user terminal in the user terminal information record as user terminal information; and
monitoring the cell and updating the user terminal information record when it is determined that a user terminal having a varied communication behavior exists in the cell, when it is determined that the identification exists in the user terminal information record, and recording the identification into the user terminal information record when it is determined that the identification does not exist in the user terminal information record.

19. The method as claimed in claim 16, wherein the cell adopts a peer-to-multi peer transmission mode in the informing the plurality of user terminals in the cell in which the MBMS is transmitted of initiation of counting, and
wherein the updating the user terminal information record when it is determined that a user terminal having a varied communication behavior exists in the cell comprises:
determining that the user terminal having a varied communication behavior exists in the cell and adding the information of the user terminal into the user terminal information record when a determination is made that the user terminal already participating in the MBMS service enters the cell, is powered on, or enters the service area or that the user terminal participating in the MBMS service appears in the cell;
determining that the user terminal having a varied communication behavior exists in the cell and deleting the information of the user terminal from the user terminal information record when a determination is made that the user terminal in the cell stored in the user terminal information record departs from the cell, is powered off, leaves the service area, or quits from the MBMS; and
otherwise determining that no user terminals have a varied communication behavior in the cell.

20. The method as claimed in claim 19, wherein the determining whether to trigger a re-counting comprises:
determining whether the number of user terminals in the user terminal information record is smaller than the user number threshold in the cell; and
determining to trigger a recounting when the number of user terminals in the user terminal information record is smaller than the user number threshold in the cell, and determining not to trigger a recounting when the number of user terminals in the user terminal information record is not smaller than the user number threshold in the cell.

21. The method as claimed in claim 16, wherein the cell adopts a peer-to-peer transmission mode in the informing the plurality of user terminals in the cell in which the MBMS is transmitted of initiation of counting, and
wherein the updating the user terminal information record when it is determined that a user terminal having a varied communication behavior exists in the cell comprises:
determining that the user terminal having a varied communication behavior exists in the cell and deleting the information of the user terminal from the user terminal information record when a determination is made that the user terminal stored in the user terminal information record departs from the cell, is powered off, or leaves the service area or that the user terminal quits from the MBMS;
determining that the user terminal having a varied communication behavior exists in the cell and adding the information of the user terminal into the user terminal information record when a determination is made that the user terminal already participating in the MBMS service enters the cell, is powered on, or enters the service area or that the user terminal participating in the MBMS exists; and
otherwise determining that no user terminals with a varied communication behavior exist in the cell.

22. The method as claimed in claim 21, wherein the determining whether to trigger a recounting comprises:
determining whether the number of user terminals in the user terminal information record is greater than the user number threshold in the cell; and
determining to trigger a recounting when the number of user terminals in the user terminal information record is greater than the user number threshold in the cell, and determining not to trigger a recounting when the number of user terminals in the user terminal information record is not greater than the user number threshold in the cell.

23. The method as claimed in claim 19, wherein the adding the information of the user terminal into the user terminal information record includes adding the information of the user terminal into the user terminal information record as a new item, and adding 1 to the number of the user terminals in the user terminal information record.

24. The method as claimed in claim 19, wherein the adding the information of the user terminal into the user terminal information record includes replacing user terminal information in the user terminal information record with the information of the user terminal to be added, and maintaining the number of the user terminals in the user terminal information record to be unchanged.

25. The method as claimed in claim 19, wherein the deleting the information of the user terminal from the user terminal information record includes removing the information of the user terminal from the user terminal information record, and subtracting 1 from the number of the user terminals in the user terminal information record.

26. The method as claimed in claim 16, wherein before informing the user terminals in the cell about initiation of re-counting after determining to trigger a re-counting, the determining whether to trigger a re-counting comprises: cleaning up the user terminal information record.

27. The method as claimed in claim 16, wherein a transmission mode switching condition is pre-set, and before informing the user terminals in the cell about initiation of re-counting after a determination is made to trigger a re-counting, the determining whether to trigger a re-counting further comprises:
determining a counting result according to the number of the user terminals in the user terminal information record, and switching the transmission mode in the cell to another transmission mode when a determination is made to switch the transmission mode according to the counting result and a transmission mode switching condition.

28. A network control device providing a counting operation, comprising:
a control module sending a notification indicating initiation of counting;
a storage module used to store a user terminal information record and a user number threshold in a cell; and
a communication module receiving the notification indicating initiation of counting from the control module, sending out the received notification to the user terminals in the cell, receiving responses from the user terminals, and sending the received responses to the control module,
wherein the control module receives the responses from the user terminals from the communication module, sends information of the responding user terminals to the storage module, obtains the user terminal information record and the user number threshold in the cell from the storage module, monitors the cell in which multimedia broadcast and multicast service is transmitted, informs the storage module to update the user terminal information record, and determines whether to trigger a recounting according to the number of user terminals and the user number threshold in the cell in the user terminal information record.

29. The device as claimed in claim 28, wherein the storage module additionally stores counting results and transmission switching conditions, and the control module additionally sends the counting result of each recounting to the storage module, obtains the counting result and the transmission switching conditions from the storage module, and switches a transmission mode of the cell to a different transmission mode when a determination is made to switch the transmission mode according to the obtained transmission mode switching conditions and the counting result.

30. The device as claimed in claim 28, wherein the network control device is a radio network controller or eNode B.
